(19) United States
(12) Patent Application Publication
(10) Pub. No.: US 2016/0196467 A1
(43) Pub. Date: Jul. 7, 2016

(54) Three-Dimensional Face Recognition Device Based on Three Dimensional Point Cloud and Three-Dimensional Face Recognition Method Based on Three-Dimensional Point Cloud

(71) Applicant: Shenzhen Weiteshi Technology Co. Ltd., Shenzhen (CN)

(72) Inventor: Chunqiu XIA, Shenzhen (CN)

(21) Appl. No.: 14/952,961

(22) Filed: Nov. 26, 2015

(30) Foreign Application Priority Data
Jan. 7, 2015 (CN) CN201510006212.5

(51) Int. Cl. G06K 9/00; G06T 7/00

(52) U.S. Cl. CPC G06K 9/00248; G06K 9/00281; G06K 9/00288; G06T 7/0081; G06T 2207/10028; G06T 2207/30201

(57) ABSTRACT

The invention describes a three-dimensional face recognition device based on three-dimensional point cloud and a three-dimensional face recognition method based on three-dimensional point cloud. The device includes a feature region detection unit used for locating a feature region of the three-dimensional point cloud, a mapping unit used for mapping the three-dimensional point cloud to a depth image space in a normalizing mode, a statistics calculation unit used for conducting response calculating on three-dimensional face data in different scales and directions through Gabor filters having different scales and directions, a storage unit obtained by training used for storing a visual dictionary of the three-dimensional face data, a map calculation unit used for conducting histogram mapping on the visual dictionary and a Gabor response vector of each pixel, a classification calculation unit used for roughly classifying the three-dimensional face data, a recognition calculation unit used for recognizing the three-dimensional face data.

### CROSS REFERENCE TO RELATED APPLICATIONS

This application claims priority to the following patent properties: Chinese Patent Application CN201510006212.5, filed on Jan. 7, 2015, the above application is hereby incorporated by reference herein in its entirety.

### BACKGROUND

1. Technical Field

The present disclosure generally relates to a three-dimensional face recognition device based on three-dimensional point cloud, and a three-dimensional face recognition method based on three-dimensional point cloud.

2. Description of Related Art

Compared with 2D face recognition, three-dimensional face recognition has some advantage, such as three-dimensional face recognition has not been seriously affected by illumination robustness, gestures and expressions, such that after three-dimensional data gathering technology has speedy developed, and quality and precision of the three-dimensional data have been greatly improved, more and more scholars start to study in this area.

One Chinese patent (applicant number: CN201010256907.6) describes a method and a system for identifying a three-dimensional face based on bending invariant related features. The method includes the following steps: extracting related features of the bending invariants by coding local features of bending invariants of adjacent nodes on the surface of the three-dimensional face; and signing the related features of the bending invariants and reducing dimension by adopting spectrum regression; obtaining main components; and identifying the three-dimensional face by a K nearest neighbor classification method based on the main components. However, it needs a complex calculation when extracting related features of the bending invariants, such that the application of the method is limited due to its low efficiency.

Another Chinese patent (applicant number: CN200910197378.4) describes a full-automatic three-dimensional human face detection and posture correction method, the method comprises the following steps of: by using three-dimensional curved surfaces of human faces with complex interference, various expressions and different postures as input and carrying out multi-dimensional moment analysis on three-dimensional curved surfaces of human faces, roughly detecting the curved surfaces of the human faces by using face regional characteristics and accurately positioning the positions of the nose tips by using nose tip regional characteristics; further accurately segmenting to form completed curved surfaces of the human faces; detecting the positions of the nose roots by using nose root regional characteristics according to distance information of the curved surfaces of the human faces; establishing a human face coordinate system; automatically correcting the postures of the human faces according to the human face coordinate system; and outputting the trimmed, complete and posture-corrected three-dimensional human faces. The method can be used for a large-scale three-dimensional human face base. The result shows that the method has the advantages of high speed, high accuracy and high reliability. However, this patent is aim at evaluating posture of three-dimensional face data, and belonged to a data preprocessing stage of three-dimensional face recognition system.

Three-dimensional face recognition is a groundwork of three-dimensional face field, most of initial work should use three-dimensional data, such as, curvature, depth and so on which can describe face, however, much data has noise points during a gathering of three-dimensional data, as features, such as curvature, are sensitive to the noise, such that the precision is low; after the three-dimensional data can be mapped to depth image data, such as principal component analysis (PCA), features of Gabor filter; however, this feature also have defects, such as: (1) the principal component analysis is a member of global representation features, such that the principal component analysis lacks the ability to describe the detail texture of three-dimensional data; (2) features of the Gabor filter lies much on the quality of the obtained three-dimensional face data to describe the three-dimensional face data due to the noise problem of the three-dimensional data.

Therefore, a need exists in the industry to overcome the described problems.

### SUMMARY

The disclosure is to offer a three-dimensional face recognition device based on three-dimensional point cloud, and a three-dimensional face recognition method based on three-dimensional point cloud.

A three-dimensional face recognition device based on three-dimensional point cloud comprises a feature region detection unit used for locating a feature region of the three-dimensional point cloud; a mapping unit used for mapping the three-dimensional point cloud to a depth image space in a normalizing mode; a statistics calculation unit used for conducting response calculating on three-dimensional face data in different scales and directions through Gabor filters having different scales and directions; a storage unit obtained by training and used for storing a visual dictionary of the three-dimensional face data; a map calculation unit used for conducting histogram mapping between the visual dictionary and at least one Gabor response vector of each pixel; a classification calculation unit used for roughly classifying the three-dimensional face data; a recognition calculation unit used for recognizing the three-dimensional face data.

Preferably, the feature region detection unit includes a feature extraction unit and a feature region classifier unit, the feature region classifier unit is used for determining the feature region.

Preferably, the feature region classifier unit is a support vector machine or an adaboost.

Preferably, the feature region is a tip area of a nose.

A three-dimensional face recognition method based on three-dimensional point cloud comprises the following steps: a data preprocessing process: firstly a feature region of three-dimensional point cloud data is located according to features of the data, the feature region is regarded as registered benchmark data; then, the three-dimensional point cloud data is registered with basis face data; then the three-dimensional point cloud data is mapped to get at least one depth image by three-dimensional coordinate values of data; robust regions of expressions are extracted based on the data having already been mapped to the depth image; a features extracting process: Gabor features are extracted by Gabor filters to get Gabor response vectors, the Gabor response vectors cooperatively form a response vectors set of an original image; a corresponding set relation is made for each response vector and one corresponding visual vocabulary stored in a three-dimensional face visual dictionary, such that a histogram of the visual dictionary is obtained; a roughly classifying process: inputted three-dimensional face is roughly classified into specific categories based on eigenvectors of the visual dictionary; a recognition process: after the rough classifying information is obtained, the eigenvectors of the visual dictionary of the inputted data are compared with eigenvectors stored in a database corresponding to registration data of the rough classifying by a closest classifier, such that the three-dimensional face is recognized.

Preferably, the feature region is a tip area of a nose, and a method of detecting the tip area of the nose includes the following steps: a threshold is confirmed, the threshold of an average effective energy density of a domain is determined, and the threshold is defined as “thr”; data to be processed is chosen by depth information, the face data belonged in a certain depth range is extracted and defined as the data to be processed by the depth information of the data; a normal vector is calculated, direction information of the face data chosen from the depth information is calculated; the average effective energy density of the domain is calculated, the average effective energy density of each connected domain among the data to be processed is calculated according to a definition of the average effective energy density of the region, one connected domain having the biggest density value is selected; to determine whether the tip area of the nose is found, when the current threshold is bigger than the predefined “thr”, the region is the tip area of the nose, or return to the threshold confirming process, and the cycle begins again.

Preferably, the three-dimensional point cloud data is inputted to be registered with the basis face data by an ICP algorithm.

Preferably, during the feature extracting process, when tested face image is inputted and filtered by the Gabor filter, any one of filter vector is compared with all of the primitive vocabularies contained in a visual points dictionary corresponding to a location of the filter vector, each of the filter vector is mapped on a corresponding primitive closet to the filter vector through a distance matching method, such that visual dictionary histogram features of original depth images are extracted.

Preferably, the rough classifying includes training and recognition, during the training process, data set is clustered firstly, all of the data is spread to be stored in k child nodes, a center of each subclass obtained by training is stored as parameters of the rough classifying; during the recognition process of the rough classifying, inputted data is matched with each parameter of the subclasses, top n child nodes data is chosen to be matched.

Preferably, the data matching process is proceeded in the child nodes chosen in the rough classifying, each child node is returned to m registration data closet to the inputted data, n*m registration data is recognized in a host node, such that the face recognition is achieved by the closet classifier.

Compared with the traditional three-dimensional face recognition method, the invention has the following technical effects: the invention describes a completely solution of recognizing three-dimensional face, the invention includes data preprocessing process, data registration process, features extraction process, and data classification process, compared with the traditional three-dimensional face recognition method based on three-dimensional point cloud, the invention has a strong capability of descripting detail texture of three-dimensional data, and has a better capability of adapt to the quality of the inputted three-dimensional point cloud face data, such that the invention has better application prospect.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a system block diagram according to an exemplary embodiment;

FIG. 2 is a flow block diagram according to an exemplary embodiment;

FIG. 3 is an isometric view of three-dimensional tip area of the nose according to an exemplary embodiment;

FIG. 4 is a locating isometric view of three-dimensional tip area of the nose according to an exemplary embodiment;

FIG. 5 is a registrating isometric view of three-dimensional faces having different postures according to an exemplary embodiment;

FIG. 6 is an isometric view of the depth image mapped from three-dimensional point cloud data according to an exemplary embodiment;

FIG. 7 is an isometric view of the Gabor filter response of three-dimensional point cloud data according to an exemplary embodiment;

FIG. 8 is an acquiring process of the k-means clustering of three-dimensional face visual dictionary according to an exemplary embodiment;

FIG. 9 is a process of establishing vector features of three-dimensional face visual dictionary according to an exemplary embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

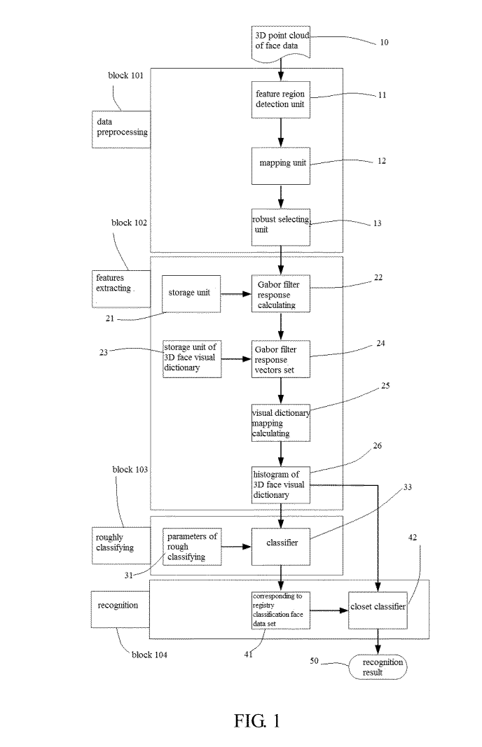

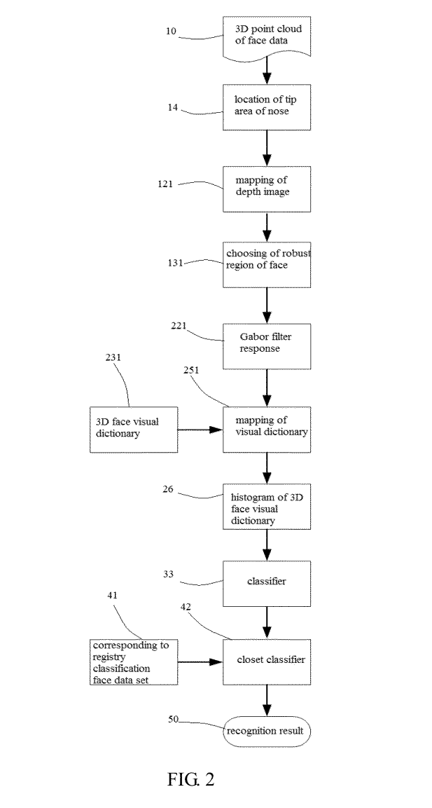

With reference to FIGS. 1-2, the invention describes a three-dimensional face recognition device based on three-dimensional point cloud 10 which includes a feature region detection unit 11 which can be used for locating a feature region of the three-dimensional point cloud; a mapping unit 12 which can be used for mapping the three-dimensional point cloud to a depth image space in a normalizing mode; a statistics calculation unit which can be used for conducting response calculating 22 on three-dimensional face data in different scales and directions through Gabor filters having different scales and directions; a storage unit 21 obtained by training and used for storing a visual dictionary of the three-dimensional face data; a map calculation unit which can be used for conducting histogram mapping between the visual dictionary and a Gabor response vector of each pixel; a classification calculation unit which can be used for roughly classifying the three-dimensional face data; a recognition calculation unit which can be used for recognizing the three-dimensional face data.

And, the feature region detection unit includes a feature extraction unit and a feature region classifier unit which can be used for determining the feature region; the sign extraction unit is aim at features of the three-dimensional point cloud, such as data depth, data density, internal information, and the other features extracted from point cloud data, the internal information can be three dimensional curvature obtained from a further calculating; the feature region classifier unit can classify data points based on the features of the three-dimensional point to determine whether the data points belong to the feature region; the feature region classifier unit can be a strong classifier 33, such as a support vector machine, or an adaboost and so on.

An empty point density of a tip area of a nose is high, and a curvature of the tip area of the nose is obvious, such that the feature region is generally the tip area of the nose.

The mapping unit can set spatial information (x, y) as a reference spatial-position of the mapping, spatial information (z) can be regarded as a corresponding data value of the mapping, such that a depth image can be mapped from the three-dimensional point cloud, and the original three-dimensional point cloud can be mapped to form the depth image according to depth information.

As data noise points are existed during a gathering process of the three-dimensional data, the filters can be used to filter out data noise, the data noise points can be data holes or data jump points.

Referring to FIGS. 1-2, the invention discloses a three-dimensional face recognition method based on three-dimensional point cloud of face 10. The method is provided by way of example, as there are a variety of ways to carry out the method. The method described below can be carried out using the configurations illustrated in FIG. 1, for example, and various elements of the figures are referenced in explaining method. Each block shown in FIG. 1 represents one or more process, methods or subroutines, carried out in the method. Furthermore, the order of blocks is illustrative only and the blocks can change according to the present disclosure. Additional blocks can be added or fewer blocks can be utilized, without departing from this disclosure. The method for making the hinge can begin at block 101.

At block 101, an identification pretreatment process: firstly, the feature region of the three-dimensional point cloud data can be located according to features of data, the feature region can be regarded as registered benchmark data; then, the three-dimensional point cloud data can be registered with basis face data; then the three-dimensional point cloud data is mapped to get at least one depth image 121 by three-dimensional coordinate values of data; robust regions of expressions can be extracted based on the data having been mapped to the depth image.

At block 102, a features extracting process: features can be extracted by Gabor filters to get Gabor response vectors, the Gabor response vectors cooperatively form a response vectors group of the original image; a corresponding set relation can be made for each response vector and one corresponding visual vocabulary stored in a three-dimensional face visual dictionary 231, such that a histogram of the visual dictionary 26 is obtained.

At block 103, a roughly classifying process: inputted three-dimensional face can be roughly classified into specific categories based on eigenvectors of the visual dictionary.

At block 104, after the rough classifying information is obtained, eigenvectors of the visual dictionary of the inputted data can be compared with eigenvectors stored in a database corresponding to registration data of the rough classifying by a closest classifier 42, such that the three-dimensional face is recognized, and a recognition result 50 can be achieved.

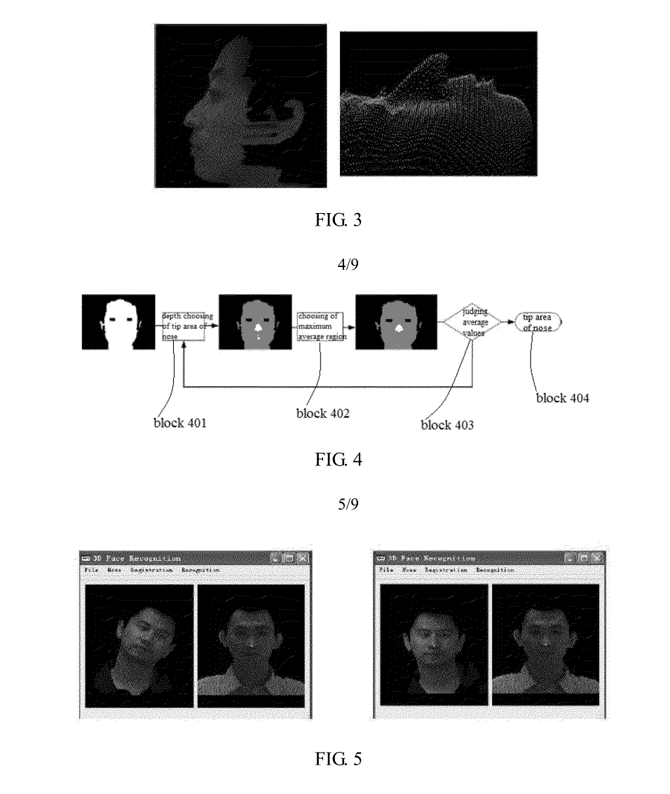

Referring to FIGS. 3-4, three-dimensional tip area of the nose has a highest z value (a depth value), an obvious curvature value, and a bigger data density value, such that the tip area of the nose is an appropriate reference region of data registration. In the invention, the feature region is the tip area of the nose, and locating of the tip area of the nose 14 can be detected by the following steps:

a threshold is confirmed, the threshold of an average effective energy density of a domain can be determined, and the threshold can be defined as “thr”;

data to be processed can be chosen by the depth information, face data belonged in a certain depth range can be regarded as the data to be processed by the depth information of the data;

a normal vector is calculated, direction information of the face data chosen from the depth information can be calculated;

the average effective energy density of the domain can be calculated, the average effective energy density of each connected domain among the data to be processed can be calculated, according to the definition of the average effective energy density of the region, one connected domain having the biggest density value can be selected;

to determine whether the tip area of the nose is found, when the current threshold is bigger than the predefined “thr”, the region is the tip area of the nose, or return to step 1 and the cycle begins again.

Referring to FIG. 5, after the reference region of data registration which can be the tip area of the nose is obtained from different three-dimensional data, the reference region of data registration can be registered according to an ICP algorithm; a comparison between before and after the registration can be referred to FIG. 5.

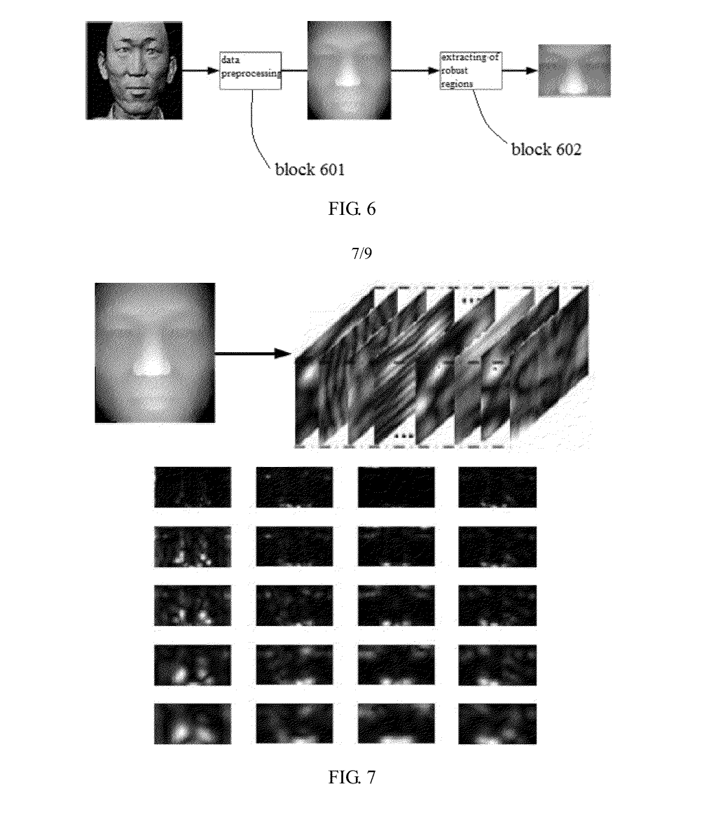

FIG. 6 is an isometric view of registering the three-dimensional point cloud to the depth image which include the following steps: at block 601, a data preprocessing process has the following steps: after the different three-dimensional data are registered with the reference region, the depth image can be obtained according to the depth information firstly, then, data noise points existed in the mapped depth image, such as data holes or data jump points, can be filter out by the filters, at block 602, robust regions of expressions can be chosen 131 to get a final depth image of the three-dimensional face.

FIG. 7 is an isometric view of the Gabor filter response 221 to the three-dimensional face data. Three dimensional depth image of each scale and direction can get response from one corresponding frequency domain. For example, a kernel function having four directions and five scales can get twenty frequency domain responding images. Pixel points of each depth image can get twenty dimensional vectors corresponding frequency domain response vectors.

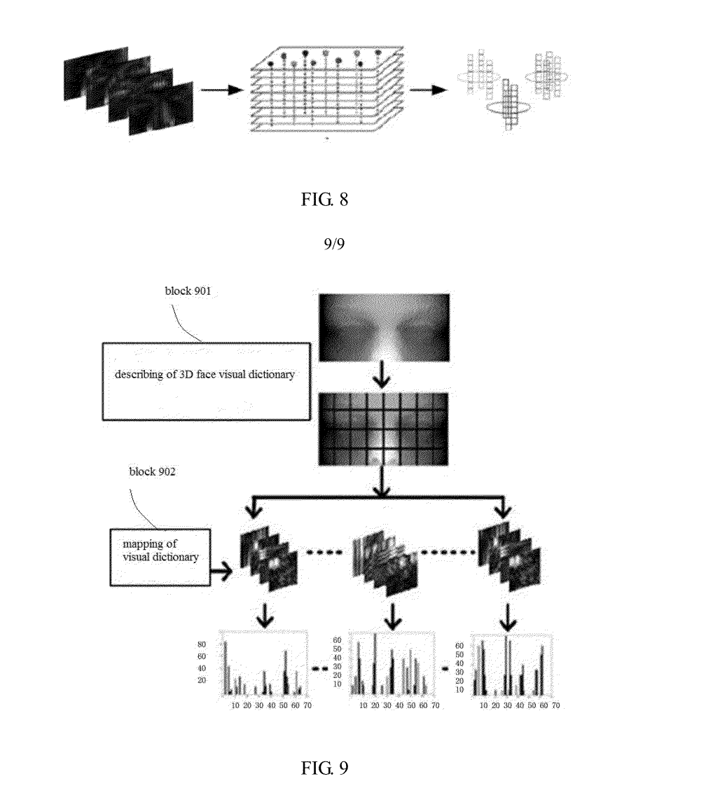

FIG. 8 is an acquisition process of k means of the three-dimensional face visual dictionary. Groups of Gabor filter response vectors of mass data can be k-mean clustered during a training of three-dimensional face data, such that the visual dictionary can be obtained. During the experimental data, a size of each depth face image can be 80×120. A hundred face images having neutral expressions can be chosen arbitrarily and defined as a training set. If the Gabor filter response vectors data of the one hundred face images having neutral expressions are directly stored in a three-dimensional tensor, a scale of the three-dimensional tensor can be 5×4×80×120×100, and the three-dimensional tensor has twenty dimensional vectors, and a number of the twenty dimensional vectors can be nine hundred and sixty thousand. A size of twenty dimensional vectors is too large for k-mean clustering algorithm. In order to solve this problem, the face data should be divided into a series of local texture images, and each local texture can be distributed with one three-dimensional tensor to storage its Gabor filter response data. By decomposing the original data, the three-dimensional tensor of each local texture can have a size of about 5×4×20×20×100, and the size of three-dimensional tensor is one-twenty four of the original scale of the original data, such that the efficiency of the algorithm is improved.

FIG. 9 illustrates an extracting process of visual dictionary histogram feature vectors of three dimensional depth image. When tested face image is inputted, and filtered by Gabor filter, any one of filter vector can be compared with all of the primitive vocabularies contained in the visual points dictionary corresponding to a location of filter vector; each of the filter vector can be mapped on a corresponding primitive closet to the filter vector through a distance matching method. Such that visual dictionary histogram features of original depth images can be extracted.

The extracting process of visual dictionary histogram feature vectors can include the following steps:

At block 901, a three dimensional face visual dictionary is described. That is, the depth image of the three dimensional face can be divided into a plurality of local texture region;

At block 902, each Gabor filter response vector can be mapped to a corresponding vocabulary of the visual points dictionary according to the locations of the Gabor filter response vectors, such that the visual dictionary histogram vector which can be defined as of a feature expression three-dimensional face are formed; a closet classifier 42 can be used for recognizing face finally, and L1 can be defined as a distance measures.

The rough classifying includes training and recognition, during the training process, the data set should be clustered firstly, all of the data can be spread to be stored in k child nodes, the clustering method can be k means and so on, a center of each subclass obtained by training can be stored as parameters of the rough classifying 31; during the recognition process of the rough classifying, inputted data can be matched with each parameter of subclass which can be the center of the cluster, the top n child nodes data can be chosen to be matched to induce the matched data space, such that a search range can be narrowed down, a search speed can be quicken up. In the invention, the clustering method can be a k-mean clustering method which includes the following steps:

step 1: k objects can be chosen arbitrarily from a database object, the k objects can be regarded as original class-center;

step 2: according to average values of the objects, each object can be given a new closet class.

step 3: the average values can be updated, that is, averages values of objects of each class are calculated;

step 4, step 2 and step 3 can be repeated until an end condition is happened.

The data matching process can be proceeded in the child nodes chosen in the rough classifying, each child node can be returned to m registration data closet to inputted data, n*m registration data can be recognized during a host node, such that face can be recognized by the closet classifier 42.

After the rough classifying information is obtained, visual dictionary feature vectors of the inputted information can be compared with the eigenvectors stored in database corresponding to the rough classifying registration data through the closet classifier 42. Such that three-dimensional face can be recognized.

The invention can be regarded as a completely solution of recognition of three-dimensional face, the invention includes data preprocessing, data Registration, features extraction, and data classification, compared with the traditional three-dimensional face Recognition method based on three-dimensional point cloud, the invention has a strong capability of description of detail texture of three-dimensional data, and has a better adaptability of the quality of the inputted three-dimensional point cloud face data, such that the invention has better application prospect.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A three-dimensional face recognition device based on three-dimensional point cloud, comprising:
a feature region detection unit used for locating a feature region of the three-dimensional point cloud, the feature region detection unit including a classifier;
a mapping unit used for mapping the three-dimensional point cloud to a depth image space in a normalizing mode;
a statistics calculation unit used for conducting response calculating on three-dimensional face data in different scales and directions through Gabor filters having different scales and directions;
a storage unit obtained by training and used for storing a visual dictionary of the three-dimensional face data;
a map calculation unit used for conducting histogram mapping on the visual dictionary and a Gabor response vector of each pixel;
a classification calculation unit used for roughly classifying the three-dimensional face data;
a recognition calculation unit used for recognizing the three-dimensional face data, wherein eigenvectors of the visual dictionary are compared with eigenvectors stored in a database by the classifier, such that the three-dimensional face is recognized.

2. The three-dimensional face recognition device based on three-dimensional point cloud of claim 1, wherein the feature region detection unit includes a feature extraction unit and a feature region classifier unit, the feature region classifier unit is used for determining the feature region.

3. The three-dimensional face recognition device based on three-dimensional point cloud of claim 1, wherein the classifier is a support vector machine or an adaboost.

4. The three-dimensional face recognition device based on three-dimensional point cloud of claim 1, wherein the feature region is a tip area of a nose.

5. A three-dimensional face recognition method based on three-dimensional point cloud, comprising the following steps:
a data preprocessing process: firstly a feature region of three-dimensional point cloud data being located according to features of data, the feature region being regarded as registered benchmark data; then, the three-dimensional point cloud data being registered with basis face data; then the three-dimensional point cloud data being mapped to get at least one depth image by three-dimensional coordinate values of data; robust regions of expressions being extracted based on the data having already been mapped to the depth image;
a features extracting process: Gabor features being extracted by Gabor filters to get Gabor response vectors, the Gabor response vectors cooperatively forming a response vectors set of an original image; a corresponding set relation being made for each response vector and one corresponding visual vocabulary stored in a three-dimensional face visual dictionary, such that a histogram of the visual dictionary being obtained;
a roughly classifying process: inputted three-dimensional face being roughly classified into specific categories based on eigenvectors of the visual dictionary;
a recognition process: after rough classifying information being obtained, eigenvectors of the visual dictionary of inputted data being compared with eigenvectors stored in a database corresponding to registration data of the rough classifying by a closest classifier, such that the three-dimensional face being recognized.

6. The three-dimensional face recognition method based on three-dimensional point cloud of claim 5, wherein the feature region is a tip area of a nose, and a method of detecting the tip area of the nose includes the following steps:
a threshold is confirmed, the threshold of an average effective energy density of a domain is determined, and the threshold is defined as “thr”;
data to be processed is chosen by depth information, the face data belonged in a certain depth range is extracted and regarded as the data to be processed by the depth information of the data;
a normal vector is calculated, direction information of the face data chosen from the depth information is calculated;
the average effective energy density of the domain is calculated, the average effective energy density of each connected domain among the data to be processed is calculated according to a definition of the average effective energy density of the region, one connected domain having the biggest density value is selected;
to determine whether the tip area of the nose is found, when the current threshold is bigger than the predefined “thr”, the region is the tip area of the nose, or return to the threshold confirming process, and the cycle begins again.

7. The three-dimensional face recognition method based on three-dimensional point cloud of claim 5, wherein the three-dimensional point cloud data is inputted to be registered with the basis face data by an ICP algorithm.

8. The three-dimensional face recognition method based on three-dimensional point cloud of claim 5, wherein during the feature extracting process, when tested face image is inputted and filtered by the Gabor filter, any one of filter vector is compared with all of the primitive vocabularies contained in a visual points dictionary corresponding to a location of the filter vector, each of the filter vector is mapped on a corresponding primitive closet to the filter vector through a distance matching method, such that visual dictionary histogram features of original depth images are extracted.

9. The three-dimensional face recognition method based on three-dimensional point cloud of claim 5, wherein the rough classifying includes training and recognition, during the training process, data set is clustered firstly, all of the data is spread to be stored in k child nodes, a center of each subclass obtained by training is stored as parameters of the rough classifying; during the recognition process of the rough classifying, inputted data is matched with each parameter of the subclasses, top n child nodes data is chosen to be matched.

10. The three-dimensional face recognition method based on three-dimensional point cloud of claim 9, wherein the data matching process is proceeded in the child nodes chosen in the rough classifying, each child node is returned to m registration data closet to the inputted data, n*m registration data is recognized during a host node, such that the face is recognized by the closet classifier.
